(19) United States
(12) Patent Application Publication
(10) Pub. No.: US 2004/0205453 A1
(43) Pub. Date: Oct. 14, 2004

(54) Document distribution to mobile computing device

(76) Inventor: Sterling Mortensen, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/941,467

(22) Filed: Aug. 29, 2001

(51) Int. Cl. G06F 15/16; G06F 15/00; G06F 17/00; G06F 17/21; G06F 17/24

(52) U.S. Cl. 715/500; 709/246

(57) ABSTRACT

A system and method of distributing an electronic document to a mobile computing device including a display includes translating a data file of the electronic document into a translated data file for the electronic document, transferring the translated data file for the electronic document to the mobile computing device, and displaying the electronic document on the display of the mobile computing device. As such, translating the data file of the electronic document into the translated data file includes identifying a print format of the electronic document and displaying the electronic document on the mobile computing device includes converting the translated data file for the electronic document into display instructions for the electronic document and displaying the electronic document based on the display instructions in accordance with the print format.

### THE FIELD OF THE INVENTION

The present invention relates generally to document delivery services, and more particularly to a system and method of distributing an electronic document to a mobile computing device for display on the mobile computing device.

### BACKGROUND OF THE INVENTION

Typically, a creator of an electronic document has limited options available to them for distribution of the document to readers. The creator of the document, for example, may print the document at a printer and physically deliver the document to the readers or may send the document electronically as an attachment to an electronic mail message to the readers.

Unfortunately, printing and physically delivering the document is laborious and costly. For example, the creator of the document must allocate time beyond creation of the document to coordinate printing and delivery of the document. In addition, the actual costs of printing and delivering of the document must be accounted for. Expectedly, the labor and cost associated with printing and physically delivering the document are both compounded by the size of the document and the number of readers to which the document is to be delivered. Printing and physically delivering the document, therefore, is often inefficient.

While sending the document electronically as an e-mail attachment may be more efficient than printing and physically delivering the document, display of the document from the attachment is often inconsistent. More specifically, when the readers open the e-mail attachment for the document, format options of the document, such as page margins and/or layout of the document, may vary from those initially associated with the document and/or may vary from reader to reader. Variations in format options of the document may result, for example, when different readers have different e-mail programs and/or different versions of an application or program for opening the document. Thus, a format for the document, as intended by the creator, may be lost.

Accordingly, a need exists for efficiently distributing a document to one or more readers such that a format of the document is retained and remains consistent when displayed for each of the readers. In addition, a need exists for allowing documents created by various applications or sources to be sent to one reader.

### SUMMARY OF THE INVENTION

One aspect of the present invention provides a method of distributing an electronic document to a mobile computing device including a display. The method includes translating a data file of the electronic document into a translated data file for the electronic document, transferring the translated data file for the electronic document to the mobile computing device, and displaying the electronic document on the display of the mobile computing device. Translating the data file of the electronic document into the translated data file includes identifying a print format of the electronic document and displaying the electronic document on the mobile computing device includes converting the translated data file for the electronic document into display instructions for the electronic document and displaying the electronic document based on the display instructions in accordance with the print format.

Another aspect of the present invention provides a system for distributing an electronic document to a mobile computing device including a display. The system includes a processor adapted to translate a data file of the electronic document into a translated data file for the electronic document and a communication link configured to link the processor and the mobile computing device. The translated data file includes a print format of the electronic document and the processor is adapted to transfer the translated data file to the mobile computing device via the communication link. As such, the mobile computing device is adapted to convert the translated data file into display instructions for the electronic document and the display of the mobile computing device is adapted to display the electronic document based on the display instructions in accordance with the print format.

### BRIEF DESCRIPTION OF THE DRAWINGS

FIG. 1 is a block diagram illustrating one exemplary embodiment of a document distribution system according to the present invention.

FIG. 2 is a diagram illustrating one exemplary embodiment of a user interface of the document distribution system of FIG. 1.

FIG. 3 is a diagram illustrating one exemplary embodiment of a print format of a document distributed by the document distribution system of FIG.

FIG. 4 is a block diagram illustrating one exemplary embodiment of information flow through a portion of the document distribution system of FIG. 1.

FIG. 5 is a block diagram illustrating another exemplary embodiment of the document distribution system of FIG. 1.

FIG. 6 is a block diagram illustrating another exemplary embodiment of a portion of the document distribution system of FIG. 1.

FIG. 7 is a flow diagram illustrating one exemplary embodiment of a method of distributing a document according to the present invention.

FIG. 8 is a flow diagram illustrating one exemplary embodiment of translating a data file in the method of FIG. 7.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

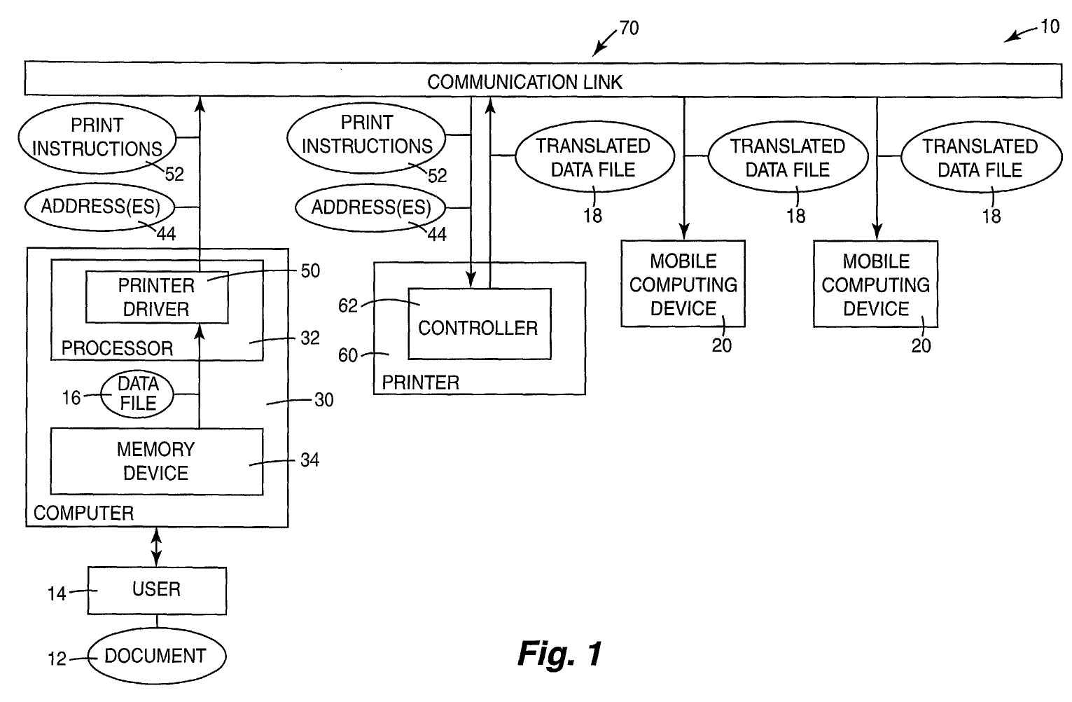

A document distribution system according to the present invention is illustrated generally at 10 in FIG. 1. Document distribution system 10 facilitates distribution of a document 12 of a user 14 to one or more mobile computing devices 20. Document 12, as used herein, is defined to include any information presented in textural and/or graphical form. User 14, as used herein, is defined to include an entity or entities such as a consumer, an employee, or a system requesting, soliciting, and/or using distribution services for a document.

Mobile computing device 20, as used herein, is defined to include any portable device which provides computing and information storage and retrieval capabilities. Mobile computing device 20 includes, for example, any small, hand-held device or appliance such as a personal digital assistant (PDA), pocket PC, connected organizer, electronic book (eBook) reader, or other handheld.

In one exemplary embodiment, document 12 is represented in electronic form as a data file 16. In accordance with the present invention, data file 16 is translated, as a translated data file 18, into a file format which facilitates the transfer or exchange of data with mobile computing device 20. Translated data file 18 includes, for example, an exchange file format such as a Tag Image File Format (TIFF) including, when mobile computing device 20 is an eBook reader, an eBook file format such as Microsoft Reader format, RocketBook format, or SoftBook format. As such, translated data file 18 for document 12 is transferred to one or more mobile computing devices 20, as described below.

As illustrated in FIG. 1, user 14 interacts with a computer 30 to initiate distribution of document 12. Computer 30 may include, for example, an input device such as a keyboard and/or a mouse and a display device such as a monitor, as is well known in the art. In addition, computer 30 may be an appliance such as a personal digital assistant (PDA), scanner, camera, cellular phone, etc.

Computer 30 includes a processor 32 and a memory device 34. Processor 32 includes logic circuitry which responds to and processes instructions which control computer 30. Processor 32 can be or can be included in a computer server or other microprocessor-based system capable of performing a sequence of logic operations. In addition, processor 32 can be or can be included in a microprocessor embedded system/appliance incorporating tailored appliance hardware and/or dedicated single-purpose hardware. Examples of memory device 34 include non-volatile memory (e.g., a hard disk drive or other persistent storage device) and may include volatile memory (e.g., random access memory (RAM)). As such, data file 16 for document 12 is stored in memory device 34.

In one exemplary embodiment, computer 30 runs an operating system which can support one or more applications. The operating system is stored in memory device 34 and executes on processor 32. The operating system is preferably a multi-tasking operating system which allows simultaneous execution of multiple applications, although aspects of the present invention may be implemented using a single-tasking operating system.

In one exemplary embodiment, user 14 enters document distribution system 10 and, therefore, initiates distribution of document 12 by selecting “FILE/PRINT . . . ” in a program or application running on computer 30 and by selecting document distribution system 10, or an application incorporating document distribution system 10, as the “NAME” of the printer. Thus, document distribution system 10 is launched by software installed in computer 30.

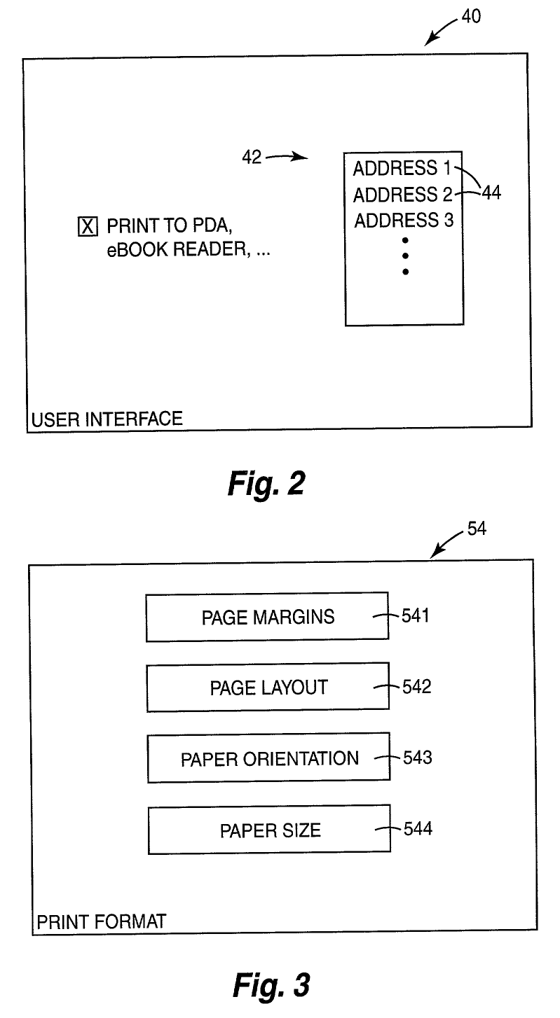

In one exemplary embodiment, as illustrated in FIG. 2, distribution options for document 12 are presented to user 14 via a user interface 40 displayed on computer 30. User interface 40 includes a plurality of input fields 42 which represent different mobile computing devices 20 to which document 12 can be distributed or sent. Each mobile computing device 20 includes, for example, a unique address which identifies a location of a respective mobile computing device 20. As such, input fields 42 represent different addresses 44 to which document 12 can be distributed or sent. Thus, user 14 selects one or more mobile computing devices 20 for distribution of document 12 by interacting with input fields 42 and selecting one or more addresses 44. In one exemplary embodiment, one or more of the addresses include a uniform resource locator (URL) for a respective mobile computing device 20.

It is to be understood that FIG. 2 is a simplified illustration of one exemplary embodiment of user interface 40. The illustrative presentation of input fields 42, for example, has been simplified for clarity of the invention. Input fields 42 may be presented, for example, as open fields, pull-down menus, toggle selections, and/or highlighted or framed selections. In addition, user interface 40 may be presented, for example, in one or more screens or views.

In one exemplary embodiment, computer 30 includes a driver, such as printer driver 50, which operates on processor 32 and translates data file 16 for document 12 into print instructions 52 for document 12. Print instructions 52 identify, for example, a print format 54 of document 12.

As illustrated in FIG. 3, print format 54 of document 12 includes, for example, one or more page margins 541 for document 12, a page layout 542 for document 12, a paper orientation 543 for document 12, and a paper size 544 for document 12. Page margins 541 include, for example, top, bottom, and/or side margins for document 12. Page layout 542 includes, for example, line and/or page numbering as well as page and/or section breaks for document 12. Paper orientation 543 includes, for example, portrait or landscape orientation for document 12. Paper size 544 includes, for example, letter, legal, or A4 size paper for document 12. As such, print format 54 for document 12 identifies print criterion for document 12 as specified or selected by user 14 as a creator and/or distributor of document 12.

When user 14 enters document distribution system 10 and initiates distribution of document 12, data file 16 for document 12 is retrieved from memory device 34 and translated or processed by processor 32 and, more specifically, printer driver 50 to generate print instructions 52. In addition, addresses 44 of mobile computing devices 20 are identified as user 14 interacts with user interface 40 to select which mobile computing devices 20 document 12 is to be distributed.

In one exemplary embodiment, as illustrated in FIG. 1, document distribution system 10 includes a printer 60 which facilitates distribution of document 12 to one or more mobile computing devices 20. More specifically, printer 60 receives print instructions 52 for document 12 from computer 30, converts print instructions 52 for document 12 into translated data file 18 for document 12, and transfers translated data file 18 for document 12 to one or more mobile computing devices 20. In addition, printer 60 receives addresses 44 for mobile computing devices 20 from computer 30 and transfers translated data file 18 for document 12 to one or more mobile computing devices 20 based on addresses 44. Addresses 44 identify those mobile computing devices 20 to which user 14 has selected, via user interface 40, for distribution of document 12.

Printer 60 includes a controller 62 which controls operation of printer 60 and receives print instructions 52 for document 12 and addresses 44 for mobile computing devices 20. As such, controller 62 translates print instructions 52 for document 12 into translated data file 18 for document 12 and transfers translated data file 18 for document 12 to one or more mobile computing devices 20 based on respective addresses 44. Thus, mobile computing devices 20 display document 12 based on translated data file 18, as described below.

Computer 30, printer 60, and mobile computing devices 20 communicate with each other via a communication link 70. Thus, communications between computer 30 and printer 60, communications between printer 60 and mobile computing devices 20, and communications between computer 30 and mobile computing devices 20 are conducted over communication link 70. Communication link 70, as used herein, is defined to include a network communication link such as a local-area network (LAN) link or a wide-area network (WAN) link and/or a communication link within a computer. Communication link 70, therefore, may include an intranet communication link, an Internet communication link, or a communication bus within a computer. In addition, communication link 70 may include a wireless communication link.

In one exemplary embodiment, computer 30, printer 60, and mobile computing devices 20 are all located remote from each other (i.e., at different locations). Thus, communications between computer 30, printer 60, and mobile computing devices 20 are conducted over a network communication link. It is, however, within the scope of the present invention for computer 30 and printer 60, printer 60 and mobile computing devices 20, and/or computer 30 and mobile computing devices 20 to be located at the same location. Thus, computer 30, printer 60, and/or mobile computing devices 20 may communicate in other manners (e.g., a direct connection or communication link).

Components of document distribution system 10 can be implemented in hardware via a microprocessor, programmable logic device, or state machine, in firmware, or in software within a given device. In one embodiment, at least a portion of the software programming is written in JAVA programming language, and each of the main components communicate via communication link 70 using a communication bus protocol. For example, the present invention may or may not use a TCP/IP protocol suite for data transport. Other programming languages and communication bus protocols suitable for use with document distribution system 10 will become apparent to those skilled in the art after reading the present application.

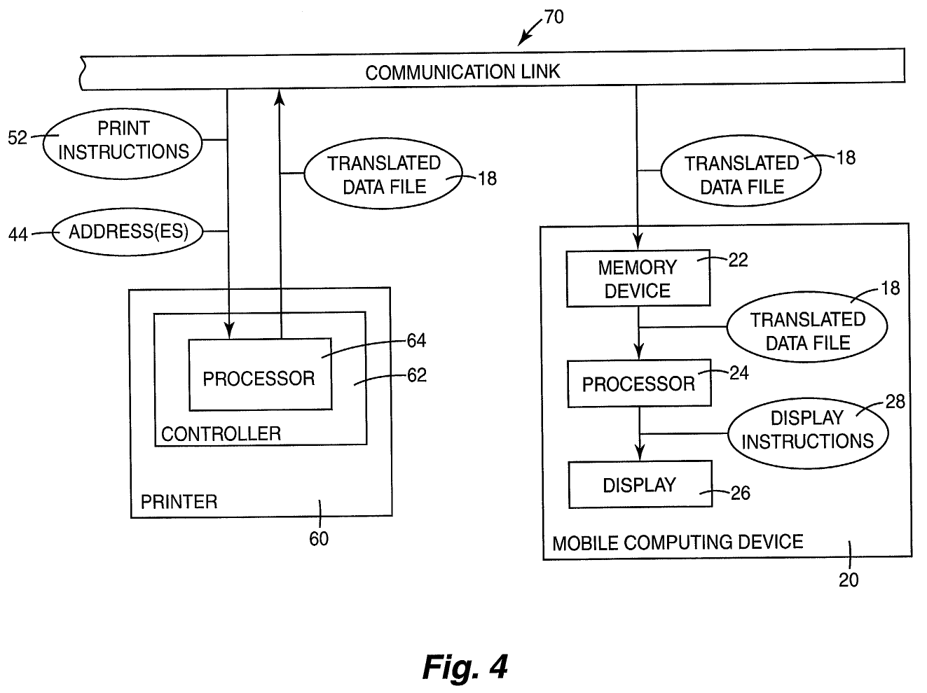

As illustrated in FIG. 4, print instructions 52 and addresses 44 are distributed to printer 60. Preferably, print instructions 52 and addresses 44 are distributed to printer 60 via communication link 70. In one exemplary embodiment, controller 62 includes a processor 64 which converts print instructions 52 into translated data file 18 and transfers translated data file 18 to one or more mobile computing devices 20 as identified by addresses 44. Preferably, printer 60 transfers translated data file 18 for document 12 to mobile computing devices 20 via communication link 70. By distributing print instructions 52 to printer 60, printer 60 can translate print instructions 52 as though printer 60 were printing document 12. Thus, a print format of document 12 can be defined and/or maintained.

Each mobile computing device 20 includes a memory device 22, a processor 24, and a display 26. Memory device 22 includes non-volatile memory (e.g., a hard disk drive or other persistent storage device) and/or volatile memory (e.g., random access memory (RAM)). As such, translated data file 18 for document 12 is stored in memory device 22. Processor 24 includes logic circuitry which responds to and processes instructions which drive mobile computing device 20. Display 26 includes a screen or other output surface which projects images to a user of mobile computing device 20. Display 26 is associated with processor 24 such that processor 24 conveys display information to display 26.

In one exemplary embodiment, processor 24 of mobile computing device 20 retrieves translated data file 18 for document 12 from memory device 22 and converts translated data file 18 into display instructions 28 for document 12. As such, processor 24 inputs display instructions 28 for document 12 to display 26 of mobile computing device 20. Thus, display 26 displays document 12 based on display instructions 28. More specifically, as display instructions 28 are based on translated data file 18 and translated data file 18 is based on print instructions 52, which identify print format 54 of document 12, display of document 12 is based on translated data file 18 for document 12 in accordance with print format 54 of document 12.

Translating data file 16 of document 12 into translated data file 18 for document 12 includes rendering data file 16 into digital bits. In one embodiment, rendering of document 12 is performed by printer 60 such that when document 12 is displayed by mobile computing device 20, document 12 is displayed with the same format as which it would be printed. Document 12, therefore, looks the same on display 26 of mobile computing device 20 as it does when printed from computer 30. Thus, display of document 12 on mobile computing device 20 has a “what you see is what you get” (WYSIWYG) effect. More specifically, what user 14 sees with document 12 at computer 30 is what is displayed on display 26 of mobile computing device 20.

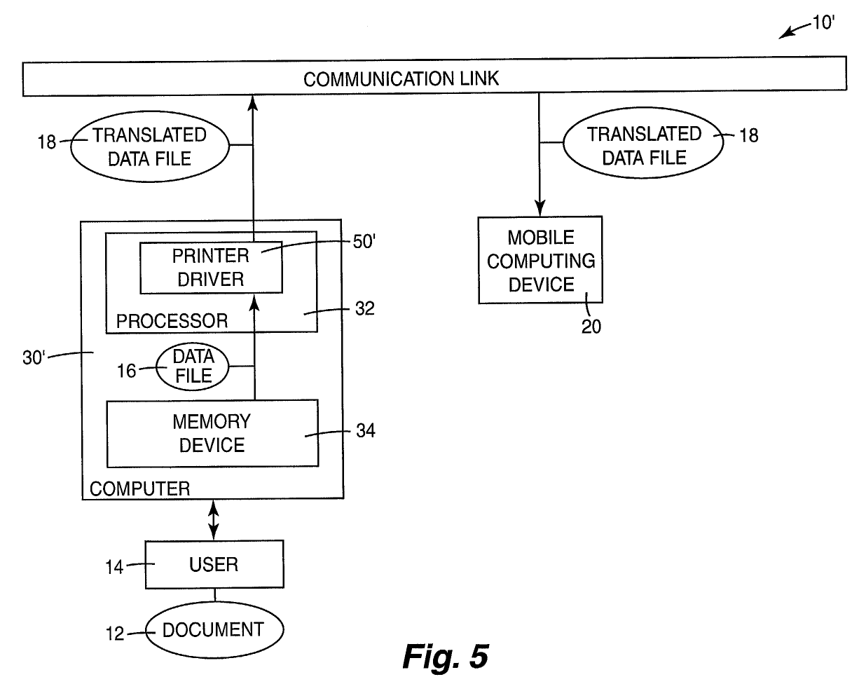

FIG. 5 illustrates another embodiment of document distribution system 10. Document distribution system 10′, similar to document distribution system 10, facilitates distribution of document 12 to mobile computing device 20. Similar to document distribution system 10, document distribution system 10′ includes a computer 30′ with which user 14 interacts to initiate distribution of document 12. Computer 30′ includes processor 32 and memory device 34 similar to that described above with reference to computer 30. Computer 30′, however, includes a printer driver 50′ which translates data file 16 for document 12 directly into translated data file 18 for document 12. As such, translated data file 18 for document 12 is transferred directly from computer 30′ to mobile computing device 20. Preferably, translated data file 18 is transferred from computer 30′ to one or more mobile computing devices 20 via communication link 70 and displayed on mobile computing devices 20 as described above.

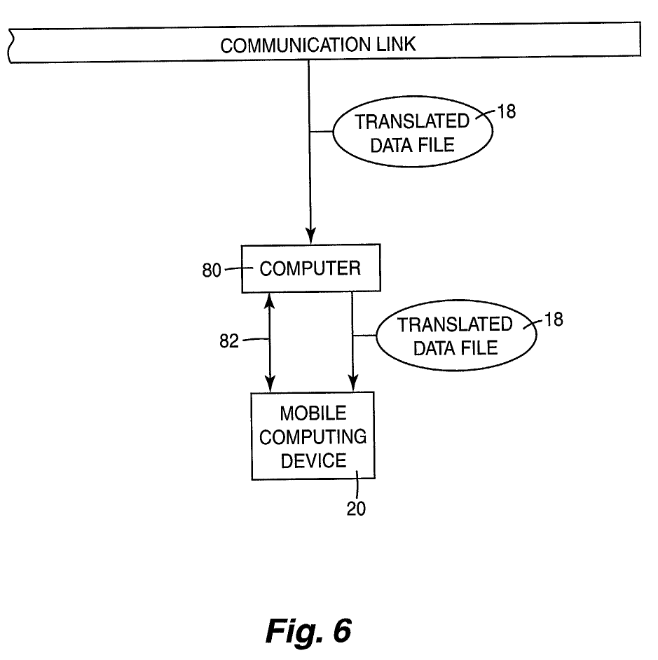

In one exemplary embodiment, as illustrated in FIG. 6, document distribution system 10, including document distribution system 10′, distributes translated data file 18 for document 12 to a computer 80 associated with a respective mobile computing device 20. As such, translated data file 18 for document 12 is transferred to mobile computing device 20 via computer 80. Mobile computing device 20 may be synchronized with computer 80, as represented by double arrow 82, such that translated data file 18 for document 12 is initially stored in computer 80 and subsequently transferred to mobile computing device 20 when mobile computing device 20 is synchronized with computer 80.

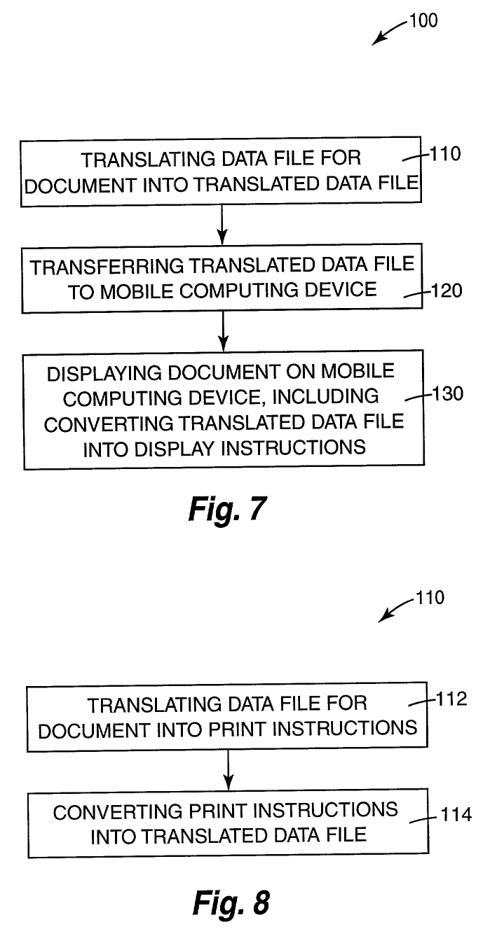

In FIG. 7, a flow diagram illustrating one exemplary embodiment of a method of distributing document 12 according to the present invention is illustrated generally at 100. Reference is also made to FIGS. 1 through 6. At step 110, data file 16 for document 12 is translated into translated data file 18 for document 12. As such, print format 54 of document 12 is identified. In one exemplary embodiment, as illustrated in FIGS. 1 and 4, step 110 is performed, in part, at computer 30 by processor 32 and, more specifically, printer driver 50 and, in part, at printer 60 by controller 62 and, more specifically, processor 64. In another exemplary embodiment, as illustrated in FIG. 5, step 110 is performed at computer 30 by processor 32 and, more specifically, printer driver 50′.

Next, in step 120, translated data file 18 for document 12 is transferred to mobile computing device 20. In one exemplary embodiment, translated data file 18 is transferred to mobile computing device 20 via communication link 70, as illustrated in FIG. 1. In another exemplary embodiment, translated data file 18 is transferred to mobile computing device 20 via communication link 70 and computer 80, as illustrated in FIG. 6.

Then, in step 130, document 12 is displayed on display 26 of mobile computing device 20. To display document 12 on mobile computing device 20, translated data file 18 for document 12 is converted into display instructions 28 for document 12 by, for example, processor 24 of mobile computing device 20. As such, display instructions 28 are transferred to display 26, as illustrated in FIG. 4.

In one exemplary embodiment, as illustrated in FIG. 8, translating data file 16 for document 12 into translated data file 18 in step 110 includes translating data file 16 of document 12 into print instructions 52 for document 12, as indicated in step 112, and converting print instructions 52 into translated data file 18 for document 12, as indicated in step 114. In one exemplary embodiment, translating data file 16 into print instructions 52 in step 112 is performed by printer driver 50 installed on computer 30 and converting print instructions 52 into translated data file 18 in step 114 is performed by controller 62 of printer 60.

By translating data file 16 of document 12 into translated data file 18 and transferring translated data file 18 to mobile computing device 20, document distribution system 10, including document distribution system 10′, retains print format 54 of document 12 while distributing document 12 to one or more mobile computing devices 20. As such, document 12 is displayed on display 26 of mobile computing device 20 with the same format as which document 12 would be printed. Thus, document 12 is displayed on display 26 of mobile computing device 20 in a manner intended by user 14 as a creator and/or distributor of document 12. In addition, document 12 is displayed the same on each mobile computing device 20 regardless of a manufacturer and/or default settings of a respective mobile computing device 20. Furthermore, document distribution systems 10 and 10′ provide “paperless” distribution of document 12 to one or more mobile computing devices 20 for consistent display thereon. As such, the labor and costs associated with printing and physically delivering document 12 is avoided.

In addition, document distribution system 10 facilitates distribution of documents created by various applications or sources to one reader or mobile computing device 20. More specifically, by utilizing print functions of a program or application running on computer 30 and processing data file 16 for document 12 by, for example, printer driver 50, any application or program that can be used to print document 12 can be used to distribute or send document 12 to mobile computing device 20. Furthermore, since most applications or programs typically include a printer driver and most users are familiar with the use of a printer driver, document distribution system 10 provides ease of use for user 14 without modification to the application or program being used to distribute or send document 12 to mobile computing device 20.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of distributing an electronic document to a mobile computing device including a display, the method comprising the steps of:
translating a data file of the electronic document into a translated data file for the electronic document, including identifying a print format of the electronic document;
transferring the translated data file for the electronic document to the mobile computing device; and
displaying the electronic document on the display of the mobile computing device, including converting the translated data file for the electronic document into display instructions for the electronic document and displaying the electronic document based on the display instructions in accordance with the print format.

2. The method of claim 1, wherein identifying the print format of the electronic document includes identifying at least one of a page margin, a page layout, a paper orientation, and a paper size for the electronic document.

3. The method of claim 1, wherein the step of translating the data file includes translating the data file of the electronic document into an exchange file format.

4. The method of claim 1, wherein the step of translating the data file includes translating the data file of the electronic document into the translated data file for the electronic document via a printer driver.

5. The method of claim 4, wherein the step of translating the data file includes translating the data file of the electronic document at a computer including the printer driver and having the data file of the electronic document stored therein.

6. The method of claim 5, wherein the step of transferring the translated data file includes transferring the translated data file for the electronic document to the mobile computing device from the computer.

7. The method of claim 6, further comprising the step of:
linking the mobile computing device and the computer via a communication link, wherein the step of transferring the translated data file includes transferring the translated data file for the electronic document to the mobile computing device from the computer via the communication link.

8. The method of claim 1, wherein the step of translating the data file includes translating the data file of the electronic document into print instructions for the electronic document and converting the print instructions into the translated data file for the electronic document.

9. The method of claim 8, wherein translating the data file of the electronic document into the print instructions includes translating the data file of the electronic document into the print instructions for the electronic document via a printer driver.

10. The method of claim 9, wherein translating the data file of the electronic document into the print instructions includes translating the data file of the electronic document into the print instructions for the electronic document at a computer including the printer driver and having the data file of the electronic document stored therein.

11. The method of claim 8, further comprising the step of:
transferring the print instructions for the electronic document to a printer, wherein converting the print instructions into the translated data file includes converting the print instructions into the translated data file for the electronic document at the printer.

12. The method of claim 11, wherein the step of transferring the translated data file includes transferring the translated data file for the electronic document to the mobile computing device from the printer.

13. The method of claim 12, further comprising the step of:
linking the mobile computing device and the printer via a communication link, wherein the step of transferring the translated data file includes transferring the translated data file for the electronic document to the mobile computing device from the printer via the communication link.

14. The method of claim 1, further comprising the step of:
identifying an address of the mobile computing device, wherein the step of transferring the translated data file includes transferring the translated data file for the electronic document to the address of the mobile computing device.

15. The method of claim 1, wherein the step of transferring the translated data file includes transferring the translated data file for the electronic document to the mobile computing device via a computer associated with the mobile computing device.

16. The method of claim 15, wherein the step of transferring the translated data file includes transferring the translated data file for the electronic document to the computer, and further comprising the step of:
synchronizing the mobile computing device with the computer, including transferring the translated data file for the electronic document to the mobile computing device from the computer.

17. A computer-readable medium having computer-executable instructions for performing a method of distributing an electronic document to a mobile computing device including a display, the method comprising:
translating a data file of the electronic document into a translated data file for the electronic document, including identifying a print format of the electronic document;
transferring the translated data file for the electronic document to the mobile computing device; and
displaying the electronic document on the display of the mobile computing device, including converting the translated data file for the electronic document into display instructions for the electronic document and displaying the electronic document based on the display instructions in accordance with the print format.

18. A system for distributing an electronic document to a mobile computing device including a display, the system comprising:
a processor adapted to translate a data file of the electronic document into a translated data file for the electronic document; and
a communication link configured to link the processor and the mobile computing device,
wherein the translated data file includes a print format of the electronic document, wherein the processor is adapted to transfer the translated data file to the mobile computing device via the communication link, and wherein the mobile computing device is adapted to convert the translated data file into display instructions for the electronic document and the display of the mobile computing device is adapted to display the electronic document based on the display instructions in accordance with the print format.

19. The system of claim 18, wherein the print format of the electronic document includes at least one of a page margin, a page layout, a paper orientation, and a paper size of the electronic document.

20. The system of claim 18, wherein the translated data file of the electronic document includes an exchange file format.

21. The system of claim 18, wherein the processor is adapted to translate the data file of the electronic document into the translated data file for the electronic document via a printer driver.

22. The system of claim 18, wherein the processor is part of a computer.

23. The system of claim 22, wherein the communication link is configured to link the computer and the mobile computing device, and wherein the computer is adapted to transfer the translated data file for the electronic document to the mobile computing device via the communication link.

24. The system of claim 18, wherein the processor includes a first processor adapted to translate the data file of the electronic document into print instructions for the electronic document and a second processor adapted to convert the print instructions into the translated data file for the electronic document.

25. The system of claim 24, wherein the first processor is adapted to translate the data file of the electronic document into the print instructions for the electronic document via a printer driver.

26. The system of claim 24, wherein the first processor is part of a computer and the second processor is part of a printer.

27. The system of claim 26, wherein the communication link is configured to link the computer, the printer, and the mobile computing device, and wherein the computer is adapted to transfer the print instructions for the electronic document to the printer via the communication link and the printer is adapted to transfer the translated data file for the electronic document to the mobile computing device via the communication link.

28. The system of claim 18, wherein the mobile computing device has an address, and wherein the processor is adapted to transfer the translated data file to the address of the mobile computing device.

29. The system of claim 18, wherein the communication link is configured to link the processor and a computer associated with the mobile computing device, and wherein the processor is adapted to transfer the translated data file for the electronic document to the mobile computing device via the communication link and the computer associated with the mobile computing device.

30. The system of claim 29, wherein the processor is adapted to transfer the translated data file for the electronic document to the computer, and wherein the computer is adapted to transfer the translated data file for the electronic document to the mobile computing device when the mobile computing device is synchronized with the computer.
